(19) United States
(12) Patent Application Publication
(10) Pub. No.: US 2022/0032968 A1
(43) Pub. Date: Feb. 3, 2022

(54) NEIGHBORHOOD WATCH SYSTEM, AND METHOD OF IMPLEMENTING SAME USING AUTONOMOUS VEHICLES

(71) Applicants: Mohana MUKHERJEE, CANTON, MI (US); Druheen Acharya DAS, CANTON, MI (US); Dron Acharya DAS, CANTON, MI (US); Amarendar Yadav MUVVA, CHEVELLA MANDAL CHEVELLA (IN); Tanay PANJA, ANN ARBOR, MI (US)

(72) Inventors: Mohana MUKHERJEE, CANTON, MI (US); Druheen Acharya DAS, CANTON, MI (US); Dron Acharya DAS, CANTON, MI (US); Amarendar Yadav MUVVA, CHEVELLA MANDAL CHEVELLA (IN); Tanay PANJA, ANN ARBOR, MI (US)

(21) Appl. No.: 16/983,503

(22) Filed: Aug. 3, 2020

(51) Int. Cl. B60W 60/00; G06K 9/00; G08B 21/00; G08B 25/10

(52) U.S. Cl. CPC B60W 60/00259; G06K 9/00798; G08B 21/00; B60W 2554/404; B60W 2420/52; B60W 2420/403; B60W 2554/20; G08B 25/10

(57) ABSTRACT

A neighborhood watch system includes a central control unit (CCU), an environment sensing units mounted on one or more autonomous vehicles which are self-driven vehicles, alarm units mounted on the autonomous vehicles, the environment sensing units being operable to continuously obtain 360° views of surroundings of the autonomous vehicle, and to send the 360° views of the surroundings to the CCU. The CCU is configured to receive the 360° views of the surroundings and to analyze the 360° views to obtain at least one object of interest stored in the CCU. When the CCU obtains the one object of interest, the CCU informs a security agency about time and location of the one object of interest, and selectively activates the alarm unit. The neighborhood watch system further includes a communication unit including one of a handheld device and a computer operatively connected with the CCU.

### BACKGROUND OF THE INVENTION

### I. Field of the Invention

The present invention relates to a neighborhood watch system for residential neighborhoods and/or commercial establishments. More particularly, the present invention relates to a neighborhood watch system which uses a plurality of autonomous vehicles, each equipped with an environment sensing unit for continuously capturing 360° views of the vehicle, for residential neighborhoods and/or for commercial establishments, and to a method of implementing the neighborhood watch system using the autonomous vehicles.

### 2. Background Art

It is well recognized that, for many people keeping residential neighborhoods and/or commercial establishments safe is a primary concern. However, most people do not have the time and/or adequate resources, or may be physically unable, to patrol the neighborhoods themselves. Additionally, relying on self-help to maintain the safety of a neighborhood may place an individual or a group of individuals in a dangerous situation, especially when the individuals are not properly trained. Also although there are private organizations, from which security agents may be hired to offer limited help for safeguarding neighborhoods, such options may quickly become prohibitively expensive. In such situations, individuals in the neighborhood typically rely upon publicly funded law enforcement agencies, e.g., police, for the safety of their neighborhoods.

However, many a times, law enforcement agencies do not have adequate resources including time and/or manpower for fully patrolling a given neighborhood or a set of adjacent neighborhoods at all hours of the day, i.e., around the clock or at intermittent hours. Such lack of patrolling and observational presence can lead to a lack of safety in the neighborhood. Especially in the neighborhoods where statistical and historical crime rates are higher, individual residents of such neighborhoods are not able to maintain peace on their own for the fear of personal safety, and law enforcement officers may put themselves at a higher risk by patrolling such dangerous neighborhoods.

The present invention attempts to solve this problem by providing a neighborhood watch system which detects safety issues by using autonomous vehicles equipped with environment sensing units, and which automatically reports the safety problems to security agencies including law enforcement agencies, neighborhood watch group, etc., without relying on residents and/or police patrolling the neighborhoods.

### SUMMARY OF THE INVENTION

In order to achieve the above objects, the present invention according to a first aspect thereof provides a neighborhood watch system. The neighborhood watch system includes a central control unit; an environment sensing unit mounted on an autonomous vehicle, the environment sensing unit being operable to continuously obtain 360° views of surroundings of the autonomous vehicle, and to send the 360° views of the surroundings to the central control unit; and an alarm unit mounted on the autonomous vehicle. The central control unit is configured to receive the 360° views of the surroundings and to analyze the 360° views to identify at least one object of interest by comparing the 360° views with images of and/or data related to objects (e.g., temperature of the surrounding, poisonous gases, color of a stolen/misplaced vehicle) stored in the central control unit, and when the central control unit identifies the one object of interest, the central control unit automatically informs a security agency about the time and location of the object of interest and/or sends an audio-visual recording of the one object of interest to the security agency, and selectively activates the alarm unit.

The environment sensing unit may include a plurality of cameras mounted on the autonomous vehicle so as to continuously obtain the 360° views of the surroundings of the autonomous vehicle. The object of interest may include at least one of an occurrence of fire, smoke and flood, a fallen tree, a fallen power line and an accident, a stolen vehicle, a stolen object and/or a misplaced item. The object of interest may also include an ongoing crime activity such as an alleged criminal or criminals on the run etc. The security agency may include one of a law enforcement agency, a neighborhood watch group, and an establishment safety watch unit.

The present invention according to another aspect thereof further includes a communication unit operatively connected with the central control unit. The communication unit is enabled by different wireless and wireline communication technologies including cellular, WiFi, Satellite, Visible Light Communications, Vehicle to Vehicle (V2V)/Vehicle to Infrastructure (V2I)/Vehicle to Pedestrians (V2P)/Vehicle to Drone (V2D)/Vehicle to Grid (V2G)/Vehicle to Cloud or Network (V2N) communications etc. The communication unit may include a communication device attached to the AV, a handheld device (including mobile phones, tablets or similar devices), and/or personal computer operatively connected with the central control unit. The communication device disposed in the autonomous vehicle, a handheld device (including mobile phones, tablets or similar devices), a personal computer is each independently operable to configure/modify the images of the objects/data related to objects (e.g., temperature of the surrounding, poisonous gases, color of a stolen/misplaced vehicle) stored in the central control unit.

The present invention according to another aspect thereof further comprises a route defining unit placed in the autonomous vehicle or placed at a remote location. The route defining unit is operable to define a route of travel for the autonomous vehicle. The central control unit is operatively connected with the route defining unit. The communication unit such as a handheld device (including mobile phones, tablets or similar devices), or a personal computer is configured to communicate with the central control unit to define a route for the autonomous vehicle. The communication unit may be located or situated inside the vehicle.

For a more complete understanding of the present invention, the reader is referred to the following detailed description section, which should be read in conjunction with the accompanying drawings. Throughout the following detailed description and in the drawings, like numbers refer to like parts.

### BRIEF DESCRIPTION OF THE DRAWINGS

FIG. 1 is a schematic of the neighborhood watch system according to the present invention.

FIG. 2 is a schematic of an environment sensing unit of the neighborhood watch system.

FIG. 3 is a schematic of a communication among various components of the neighborhood watch system.

FIG. 4 is a flowchart showing an operation of the neighborhood watch system.

FIG. 5 is a schematic of reporting of a suspicious activity to the CCU.

FIG. 6 is a schematic of autonomous vehicle receiving the alert message of the suspicious activity from the CCU

FIG. 7 is a schematic of CCU communicating with a route planning unit to set a new destination point for reaching to a suspicious vehicle.

FIG. 8 is an illustration of an autonomous vehicle finding a suspicious vehicle.

FIG. 9 is an illustration of an autonomous vehicle communicating with law enforcement agency via cellular wireless communications, and with another vehicle and pedestrian in the vicinity of the suspicious vehicle via V2V and V2P direct communications, respectively.

### DETAILED DESCRIPTION OF EXEMPLARY EMBODIMENTS OF THE INVENTION

Various aspects of the neighborhood watch system are discussed hereinafter in detail with reference to the accompanying drawings. It should be understood that these terms are used for purposes of illustration, and are not intended to limit the invention.

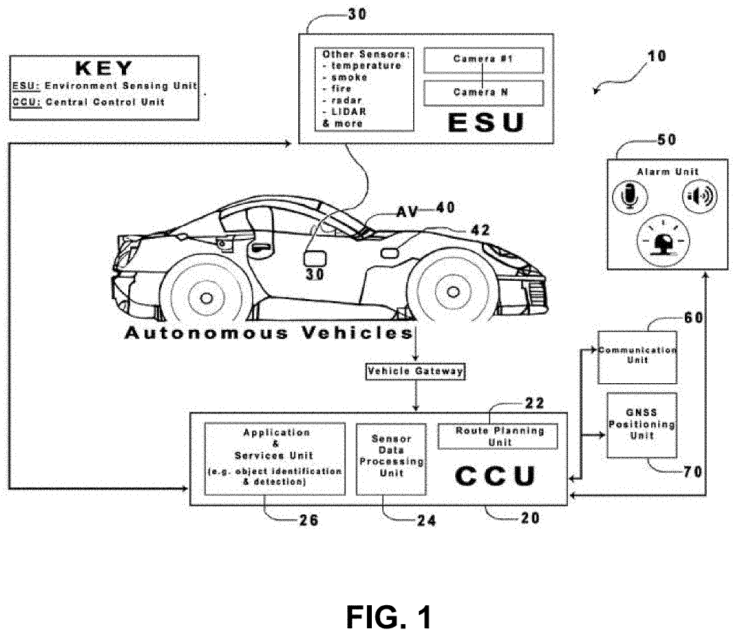

As shown in FIG. 1, the neighborhood watch system 10 includes a central control unit (CCU) 20, an environment sensing unit (ESU) 30 mounted on an autonomous vehicle (AV) 40, a route defining unit 42 arranged in the AV 40, and an alarm unit 50 mounted on the AV 40.

The AV 40 for the purpose of the present invention may be a self-driving vehicle, a driverless vehicle, a robo vehicle, a robotic car, or an automatic vehicle that is capable of moving safely with little or no human input. The AV 40 includes a variety of sensors to perceive their surroundings, such as radar, lidar, sonar, global positioning system, odometry, inertial measurement units, control systems which interpret sensory information to identify appropriate navigation paths, obstacles and road signs and signals.

As shown in FIG. 1, the CCU 20 includes a route planning unit 22, a sensor data processing unit 24, and application and services unit 26. The route planning unit 22 is configured to receive route information for intended route of the AV 40, and communicate such information to the route defining unit 42 of the AV 40 for the intended travel route of the AV 40.

The CCU 20 may be situated at a remote location, e.g., in a cloud computing location. Alternatively, the CCU may be placed in a security agency office. Furthermore, the CCU 20 may be placed in the AV 40 itself.

The ESU 30 is operable to continuously obtain 360° views of surroundings of the AV 40 when the AV 40 travels on the intended route, and to continuously and/or intermittently and/or upon instruction from the CCU 20, send the 360° views of the surroundings of the AV 40 to the CCU 20. The CCU 20 is configured to receive the 360° views of the surroundings of the AV 40 from ESU 30, to analyze the 360° views to identify at least one object of interest OI by comparing the received 360° views with base images of the objects OB stored in the CCU 20, and to selectively activate the alarm unit 40 when the CCU 20 obtains the one object of interest OI through, for example, based on comparison of the 360° views with the base images. Such comparison of the objects may include digital classification, overlapping, matching of the 360° views with a plurality of base objects OB stored in the CCU 20 to identify one or more objects of interest.

In another embodiment, when the CCU 20 obtains/identifies the one object of interest OI, the CCU 20 informs a security agency about time, location of the one object of interest OI, and selectively sends audio-visual recording of the finding of the one object of interest OI to the security agency. The application and services unit 26 of the CCU 20 generally performs identification of the object of interest OI. The application and services unit 26 includes a plurality of software programs and applications which are modifiable, as and when needed. The plurality of software programs and applications of the application and sensing unit 26 may be stored in memory, such as read-only-memory (ROM), random access memory (RAM), etc.

The CCU 20 is operatively connected with the AV 40 via a vehicle gateway which is a communication channel between the CCU 20 and the AV 40.

Further, the CCU 20 is operatively connected with a communication unit 60. The communication unit 60 may include one or more personal computers and/or handheld devices, such as mobile phones and/or tablets, operatively connected with the CCU 20. The one or more computers and/or handheld devices are operable to configure software programs and/or applications of the applications and services unit 26 of the CCU 20. Further, the one or more computers and/or handheld devices are operable to instruct the route planning unit 22 of the CCU 20 for continuing and/or for changing the travel routes, starting time and ending time of travel of the AV 40.

The environment sensing unit (ESU) 30 is mounted on the autonomous vehicle AV. The environment sensing unit 30 includes a plurality of cameras and sensors including a temperature sensor, smoke sensor, fire sensor, radar, LIDAR, etc. LIDAR is a method for measuring distances by illuminating the target with laser light and measuring the reflection with a sensor.

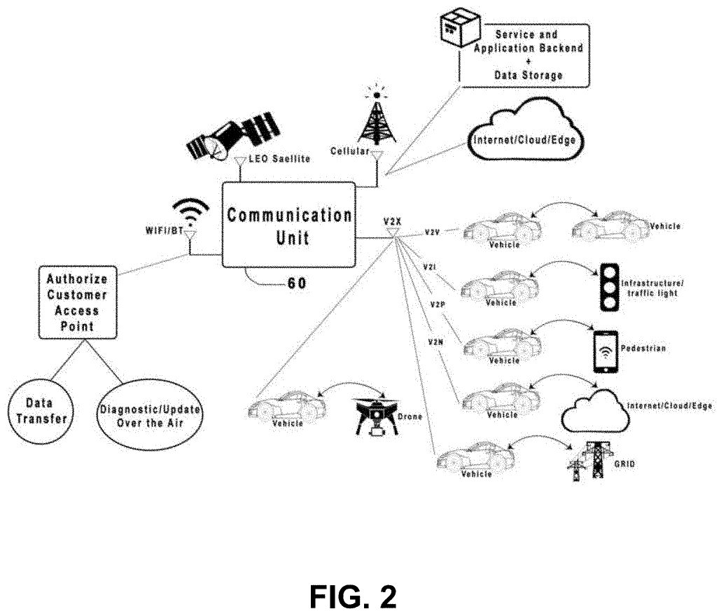

FIG. 2 shows a schematic of ESU 30. As shown in FIG. 2, the ESU 30 is operable to continually record images of 360° views of the surroundings of the AV 40, and send such 360° views of the surroundings of the AV 40 to the CCU 20.

The ESU 30 includes a plurality of sensors which are operable to sense smoke, fire, flood and poisonous gases, and continually and/or intermittently send such sensed information to the CCU 20. The various objects of interest include, for example, a lost/stolen vehicle, a neighborhood parking violation, lost/stray/wild animals, suspicious person, suspicious object, crime scene, road accident, attended/lost child, a fallen tree, a fallen power line, fire, flood, etc.

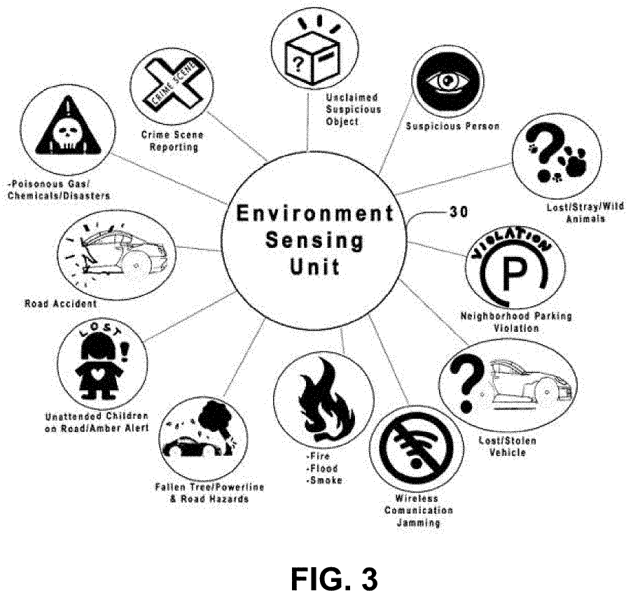

FIG. 3 is a schematic of a communication among various components of the neighborhood watch system 10.

According to the neighborhood watch system 10 of the present invention, the various established communication channels are: vehicle to vehicle (V2V), vehicle to infrastructure (V2I), vehicle to person/pedestrian (V2P), vehicle to internet/cloud/Edge (V2N), vehicle to GRID, vehicle to drone. These communications are facilitated by the communication unit.

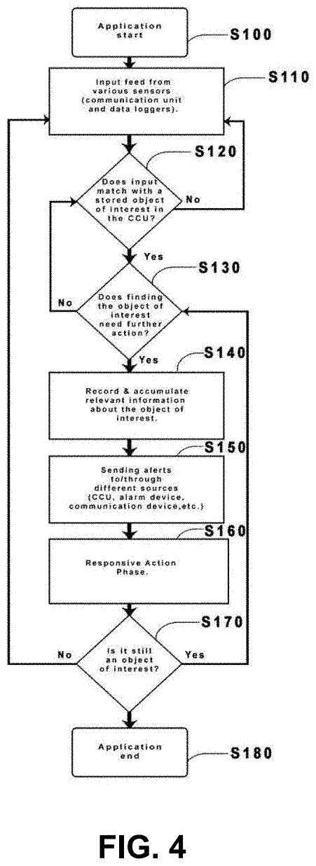

FIG. 4 shows a method of conducting a neighborhood watch using the neighborhood watch system 10.

In STEP S100, an application is started. The application is started after the AV 40 receives a route plan from the CCU 20. In STEP S110, the ESU 30 captures 360° views of the surroundings of the AV 40, and also senses various environment parameters such as temperature and smoke. As the AV 40 travels on a defined route, and continuously sends the acquired 360° views and the environment parameters to the CCU 20. In STEP S120, the 360° views and/or environment parameters received from the ESU 30 are analyzed by comparing the images and/or environment parameters with the stored base objects/images and/or environment parameters, and if the match is found, in STEP S130, it is determined whether the finding of the object of interest needs further action. If further action is required, in STEP S140, relevant information about the object of interest is recorded and accumulated, and in STEP S150, alarms/alters are selectively sent to various devices including the alarm unit located in the AV 40. After that a STEP S160, which includes a responsive action phase, is followed after alarms/alters are sent/received in STEP S150. The responsive action may include a law enforcement agency visiting the location of the object of interest and may be taking further action.

In STEP S170, it is determined whether neighborhood watch system 10 is required to further pursue finding an object of interest, and further appropriate steps are taken as shown in FIG. 4.

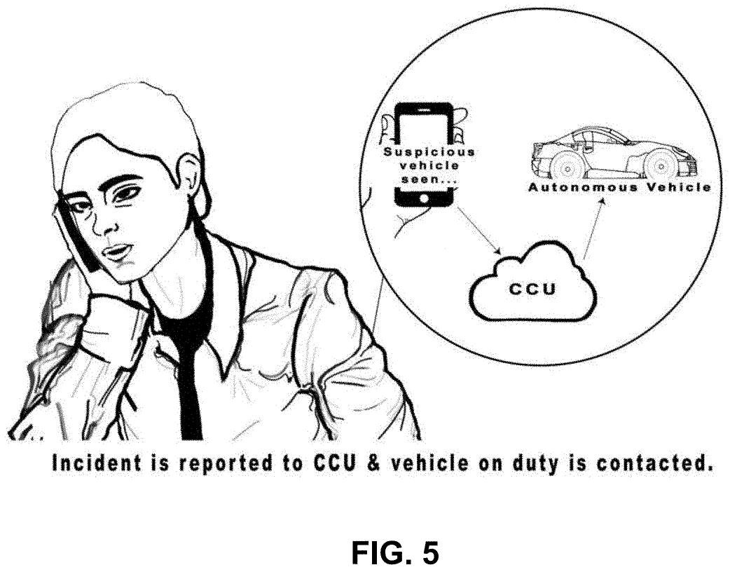

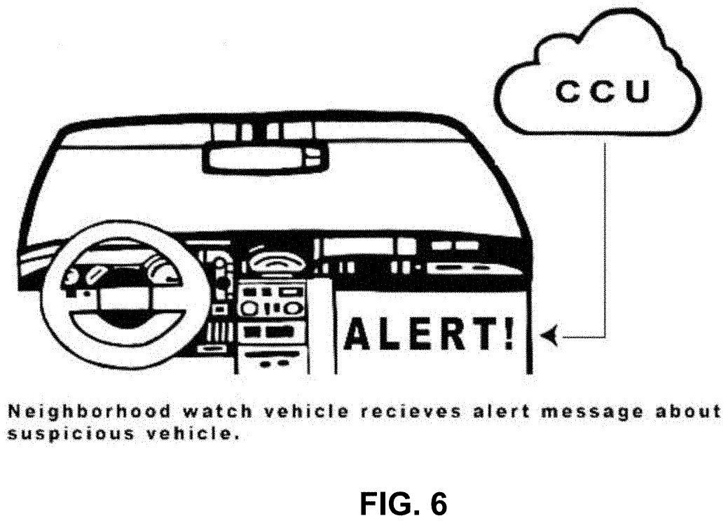

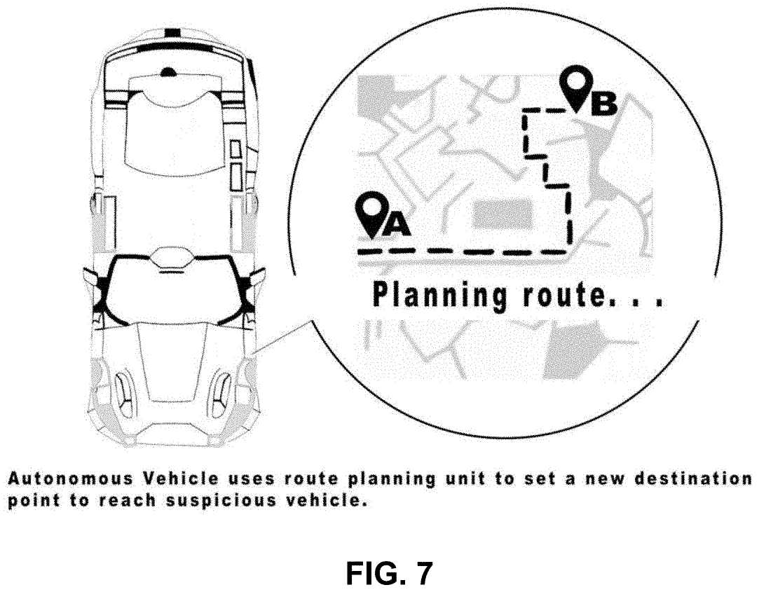

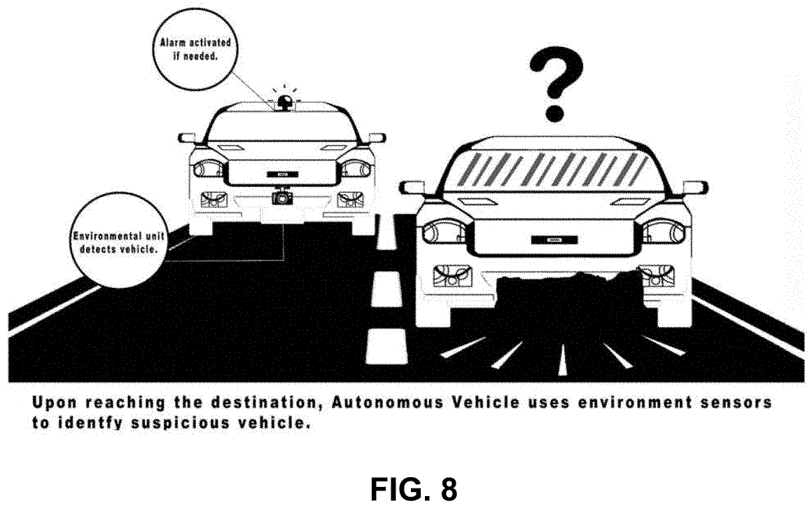

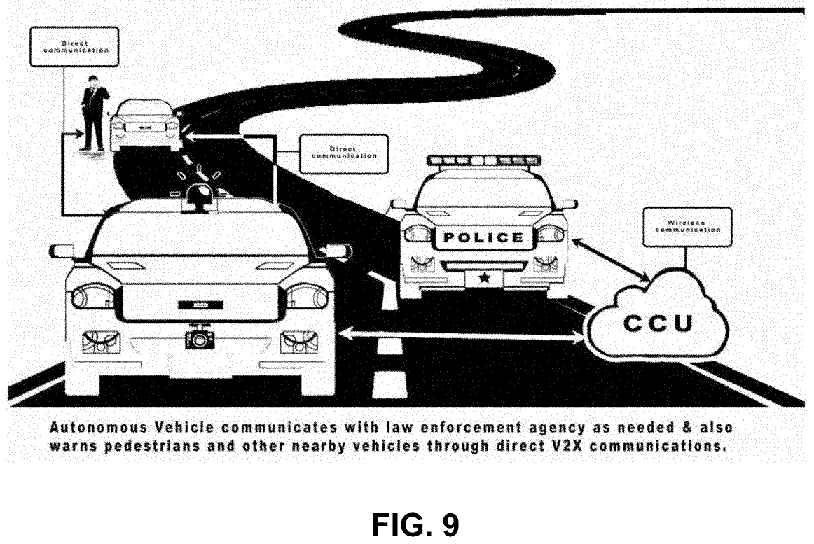

FIGS. 5-9 illustrates an example of detecting and identifying a suspicious vehicle using the neighborhood watch system. As shown in FIG. 5, when a person observes a suspicious vehicle in a neighborhood, the person communicates with the CCU 20 using the handheld device to report the sighting of the suspicious vehicle in the neighborhood. The CCU 20 further communicates the sighting to an on-duty autonomous vehicle and instructs the AV 40 to reach the location of a suspicious vehicle. As illustrated in FIG. 6, the autonomous vehicle receives an alert message from the CCU 20. The autonomous vehicle processes the information received from the CCU 20 about the suspicious vehicle. FIG. 7 illustrates an autonomous vehicle conducts a route planning to set a new destination point in order to reach a suspicious vehicle. The route planning unit can abort and/or add waypoints to the original route of an autonomous vehicle and sets a new destination point to reach the suspicious vehicle. As shown in FIG. 8, an autonomous vehicle reaches the desired destination point, detects and identifies a suspicious vehicle using environment sensing unit, and activates the alarm unit if necessary. FIG. 9 illustrates an autonomous vehicle communicates, if necessary, with a law enforcement agency using wireless communication to report suspicious vehicle. FIG. 9 also illustrates an autonomous vehicle communicates with another vehicle and pedestrian in the vicinity of the suspicious vehicle via V2V and V2P direct communications, respectively.

As discussed below, the neighborhood watch system 10 of the present invention may be implemented through several models.

### First Implementation Model

In this model, which uses an ownership based model, individual owners of autonomous vehicles in a neighborhood voluntarily participate in the neighborhood watch program. There can be indirect financial benefits, like tax benefits, reduced insurance premium etc., for those who participate. The owners register their vehicles for the neighborhood watch program in their respective neighborhoods and select available dates/times from the neighborhood watch calendar available in the program coordination site.

To facilitate such an arrangement, the present invention includes, one or more CCU 20 (also referred to as central controllers) and/or a human coordinator to manage the program. The central controller may be fully automated and may be controlled by using one or more communication devices such as a handheld device (including mobile phones, tablets or similar devices) or personal computers located at different locations. In another embodiment, the coordination can be done locally by the neighborhood association in coordination with local law enforcement offices. In another embodiment, there can be a broader perspective as well that can involve a municipal, a countywide, a citywide or even the regional/statewide level coordination. It may be noted that in this approach, there is no or very low upfront cost related to acquiring the autonomous vehicle, since vehicles are owned by individuals residing in the neighborhood. There can be some initial system integration cost for sensors and system software and hardware updates that are required for the vehicles. It may be noted that that AV 40 generally comes equipped with a plurality of sensors for object detection and identification, Global Navigation Satellite System (GNSS) and wireless communication system.

In this embodiment, a very well managed coordination is required between the program management and individual participants. A set of standards is required to be followed. This set of standards include a background check, security, vehicle level minimum performance requirements, data ownership and privacy and other matters of concern. The coordination between all entities including individual participants needs to be established and approved by applicable laws, to be supervised and closely managed. However, such an embodiment is appropriate as a ‘long term’ solution when autonomous vehicles are expected to be common in most of the households.

### Second Implementation Model

This model involves use of fleet based autonomous vehicles. A municipality, a county, a city, or a regional establishment creates, operate and manage the fleet of autonomous vehicles for neighborhood watch. This approach offers several advantage, such as, (i) uniformity of fleet vehicles, (ii) ease of coordination, (iii) data protection and privacy is relatively easier to achieve, (iv) complex legal aspects of involving privately owned vehicles can be avoided, (v) coordination and management will be more efficient.

The vehicles need not be a full-scale production grade consumer unit. A custom-built vehicle for this purpose, for example, an enclosed cart (golf cart) with autonomous driving capability may be enough. In most cases, within the neighborhood the speed limit is normally below 30 miles per hour. Therefore, an autonomous golf-cart or similar unit can be a low cost alternative to a full-scale autonomous vehicle. It will significantly reduce the cost of autonomous vehicles required for the conducting a neighborhood watch.

Although this approach requires a large upfront expenses to build/retrofit the autonomous vehicles/golf carts, it is anticipated that the immediate and long-term societal benefits of the program should be able offset such large upfront expenses.

### Third Implementation Model

In this model, a third party private security firm and/or a third party fleet operator that specializes in managing fleets of vehicles can operate in conjunction with neighborhood or county law enforcement offices to provide security services. The third party service provider can be under contract with the neighborhood to provide and manage the neighborhood watch service with autonomous vehicles for a service fee. A third party private security firm and/or fleet operator can engage their vehicles on duty to operate in a neighborhood watch program. This approach provides some of benefits of the first and second embodiments discussed above.

### Application of Autonomous Vehicles in Neighborhood Watch System

This neighborhood watch system in which an AV alone and/or along with a fleet of AVs participate to identify and report suspicious activity, and/or object of interest in the neighborhood to make the neighborhood safer.

### Requirements

An AV used in the present invention is equipped with multiple sensors, for example, a camera, LIDAR, radar, additional sensors, such as infrared sensors, night vision camera, speaker and microphone, thermal infrared camera, flash light, visible light communication device, and weather proofing and self-cleaning ability etc.

An AV 40 is equipped with information processing units, radio communications system, satellite communication system, GNSS positioning system and other types of communication, information processing and data storage devices to detect, identify, process, record, communicate and report suspicious activities and/or object of interest in the neighborhood.

An AV is equipped with multiple radio communication devices, for example, cellular, WiFi, near field communication, Bluetooth, Vehicle to Vehicle (V2V), Vehicle to Infrastructure (V2I), Vehicle to Pedestrian (V2P), Vehicle to Home/Business and Network (V2N), Vehicle to Grid (V2G) to conduct secured communication. Secured wireless communication among other participating AVs and/or surveillance Drones and law enforcement is also provided by the present invention. As discussed above, the CCU 20 is also configured to facilitate communications between the AV and vehicles, infrastructure, pedestrians, network via low earth orbit satellite communications system.

An AV is configured to independently perform a neighborhood watch in a specific neighborhood on a scheduled date and time and in a given route within a geo-fenced area which can be predefined or instantaneously decided based on circumstances.

### Implementation

(1) Residents and owners of AVs in a neighborhood can register their vehicles for participating in the neighborhood watch program. Residents may choose preferred date and time during the registration. A separate fleet of special purpose vehicles for neighborhood watch program may be created and used for this purpose.

(2) At the scheduled date and time, the AV will be able to independently report to neighborhood watch activity in the defined route and area.

(3) An AV participating in the neighborhood watch program is configured to perform the following activities independently and collaboratively:

a. Safely & independently move, maneuver, park, stop, yield to pedestrians without any assistance from human driver. Self-diagnose of vehicle health condition prior to scheduled operation is desirable for safety operation.

b. Record and process sensor data in non-volatile memory for real-time and future processing of stored data. Send real time video stream and other sensors data wirelessly to a CCU for further analyses, if required.

c. Create audible and visible alarm (sound, light) in a human recognizable way.

d. Contact residents of the neighborhood in case of any safety situation that requires attention of the residents by sending messages in the form of text messages (SMS), email, phone call, alarm, communication with installed home-security systems in neighborhood houses etc.

e. Detect and identify small animals, e.g., dogs, cats etc. Such feature is important to find an object of interest, e.g., lost animals, stray animals and/or wild animals in the neighborhood

f. Detect fire, smoke, explosions, chemical reactions including poisonous gas leakage

g. Receive instruction from the law enforcement office for special action, for example, suspicious vehicle/activity/person, amber alert, accidents and any other relevant safety event. AV must be able to perform its operation independently as per the instruction received.

h. If a resident has home security system in the house, the security device can be linked to the neighborhood watch system so that the security system can receive alert messages from the AVs. For example, the Home Security System can receive message from the AV to check all doors are locked in the household in case of a safety issue.

i. The sensor data, wireless communications log, audio-video data, route plans, and any other data related to the neighborhood watch operation will be treated as confidential.

j. Abort operation upon instruction and return to garage and park.

### Advantages of the Neighborhood Watch System

The significant advantage of the neighborhood watch system discussed in the above embodiments. It provides significant cost savings, automation and faster response time.

The added cost to AV owners in installing additional sensors and in engaging their AVs to run for extra time and miles may be compensated in different ways. For example, the AV owners can be offered savings through special insurance rate, free or discounted maintenance of the AV, free or discounted sensor suite, lower neighborhood tax, discount in local businesses etc. However, the maximum benefit comes in the form of safety and security of the locality which enhances the living standard and property valuation of the neighborhood.

Since there will be less and less human involvement in the neighborhood watch program, it is also safer and more reliable. The participating AVs can contact a large community including law enforcement instantly. The advanced sensors and communication methods also make neighborhood watch AVs more reliable than human watchers.

Although the present invention has been described herein with respect to a number of specific illustrative embodiments, the foregoing description is intended to illustrate, rather than to limit the invention. Those skilled in the art will realize that many modifications of the illustrative embodiment could be made which would be operable. All such modifications, which are within the scope of the claims, are intended to be within the scope and spirit of the present invention.

What is claimed is:

1. A neighborhood watch system comprising
a central control unit; and
an environment sensing unit mounted on an autonomous vehicle, said environment sensing unit operable to continuously obtain 360° views of surroundings of the autonomous vehicle, and to send said 360° views of the surroundings of the autonomous vehicle to the central control unit; said autonomous vehicle being a self-driven vehicle; and
an alarm unit mounted on the autonomous vehicle;
wherein the central control unit is configured to receive said 360° views of the surroundings and to analyze said 360° views to identify at least one object of interest stored by comparing said 360° views of the surroundings with base images of objects stored in the central control unit;
wherein when the central control unit identifies said one object of interest, the central control unit automatically informs a security agency about time, location of said one object of interest, selectively sends audio visual recordings of said one object of interest, and selectively activates the alarm unit.

2. The neighborhood watch system according to claim 1, wherein said environment sensing unit comprises a plurality of cameras mounted on the autonomous vehicle so to obtain the 360° views of surroundings of the autonomous vehicle.

3. The neighborhood watch system according to claim 1, wherein said environment sensing unit comprises a plurality of drones each having at least one camera mounted thereon;
wherein said plurality of drones are detachably mounted on the autonomous vehicle;
wherein said plurality of drones are selectively operable to obtain expanded views of the surroundings of the vehicle, the expanded views covering an expanded area of imaging compared that covered by the 360° views of surroundings of the autonomous vehicle.

4. A neighborhood watch system according to claim 1, further comprising a communication unit including one of a handheld device comprising a mobile phone and a personal computer operatively connected with the central control unit, wherein said communication unit is operable to configure and modify said base images of the objects stored in the central control unit.

5. The neighborhood watch system according to claim 1, further comprising a communication unit including one of a communication device arranged in the autonomous vehicle, a handheld device comprising one of a mobile phone and a personal computer operatively connected with the central control unit, wherein said communication unit is operable to configure said base images of objects stored in the central control unit;
wherein when the communication unit does not communicate with the central control unit due to a presence of a suspicious jammer, said central control unit automatically triggers an alarm in the communication unit.

6. The neighborhood watch system according to claim 1, further comprising a communication unit including at least one of a communication device arranged in the autonomous vehicle, a handheld device which includes one of a mobile phone and a tablets, and a personal computer operatively connected with the central control unit;
wherein the autonomous vehicle has a route defining unit which is operable to define a route of travel for the autonomous vehicle;
wherein the central control unit is operatively connected with said route defining unit;
wherein the communication unit is configured to communicate with the central control unit to define a route for the autonomous vehicle.

7. The neighborhood watch system according to claim 1, wherein the security agency is one of a law enforcement agency, a neighborhood watch group, and an establishment safety watch unit.

8. The neighborhood watch system according to claim 1, wherein the one object of interest includes at least one of an occurrence of fire, smoke and flood, a fallen tree, a fallen power line, and an accident.

9. The neighborhood watch system according to claim 1, wherein the one object of interest includes at least one of a stolen vehicle, a misplaced vehicle, a stolen object, and a lost pet.

10. A neighborhood watch system comprising
a central control unit;
a plurality of environment sensing units, each mounted one of a plurality of autonomous vehicles, each of said environment sensing unit operable to continuously obtain 360° views of surroundings of the corresponding autonomous vehicles when vehicles are operated, and to communicate with said central control unit so as to send said 360° views of the surroundings and geospatial information to the central control unit; and
an alarm unit mounted on each of the autonomous vehicles;
communication unit operatively connected with the central control unit, and operable to configure and modify base images of the objects stored in the central control unit.
wherein the central control unit is configured to receive said 360° views of the surroundings from the plurality of environment sensing units and to analyze said 360° views by comparing said 360° views with the base images of objects stored in the central control unit to identify at least one object of interest;
wherein when the central control unit obtains said one object of interest, the central control unit informs a security agency about time and location of obtaining said one object of interest, and selectively activates the alarm units;
wherein when the communication unit fails to communicate with the central control unit due to a presence of a suspicious jammer, said central control unit automatically triggers an alarm in the communication unit.

11. A neighborhood watch system according to claim 10, wherein said environment sensing unit comprises a plurality of cameras including night vision cameras mounted on the autonomous vehicle so to continuously obtain the 360° views of surroundings of the autonomous vehicle during night time.

12. A neighborhood watch system according to claim 10, further comprising a communication unit including a handheld device which includes one of a mobile phone, a tablet, a personal computer for each of the autonomous vehicle, said communication unit being operatively connected with the central control unit, wherein said communication unit is operable to modify said base images of the objects stored in the central control unit.

13. The neighborhood watch system according to claim 10, further comprising a communication unit including a handheld device operatively connected with the central control unit;
wherein each of the autonomous vehicles has a route defining unit which is operable to define a routine of travel for the autonomous vehicle;
wherein the central control unit is operatively connected with said route defining unit;
wherein the handheld device is configured to communicate with the central control unit to define a route for each of the autonomous vehicles.

14. The neighborhood watch system according to claim 10, wherein the security agency is one of a law enforcement agency, a neighborhood watch group, and an establishment safety watch unit.

15. The neighborhood watch system according to claim 10, wherein the one object of interest includes at least one of an occurrence of fire, smoke and flood, a fallen tree, a fallen power line, and an accident.

16. The neighborhood watch system according to claim 10, wherein the one object of interest includes at least one of a stolen vehicle, a misplaced vehicle, a stolen object, and a lost pet.

17. A method of using a neighborhood watch system, said neighborhood watch system comprising a central control unit; a plurality of environment sensing units, each mounted one of a plurality of autonomous vehicles, each of said environment sensing unit operable to continuously obtain 360° views of surroundings of the corresponding autonomous vehicle when vehicle is operated, and to send said 360° views of the surroundings and geospatial information to the central control unit; and an alarm unit mounted on each of the autonomous vehicles; each of the autonomous vehicles having a route defining unit which is operable to define a route of travel for the autonomous vehicle, the central control unit being operatively connected with said route defining unit;
the central control unit being configured to receive said 360° views of the surroundings and to analyze said 360° views by comparing the 360° views with base images of objects stored in the central control unit to identify at least one object of interest; and to inform a security agency about time and location of obtaining said one object of interest, and selectively activates the alarm unit when the central control unit obtains said one object of interest;
said method comprising the steps of;
identifying a neighborhood to be monitored for safety of persons and property;
identifying at least one route to be monitored in said neighborhood;
sending a route information and a time of initiating travel to at least one of the autonomous vehicles;
obtaining 360° views of the surroundings of the autonomous vehicles by using environment sensing units;
automatically analyzing the 360° views of the surroundings received from the environment sensing units by comparing the 360° views with the base images of objects stored in the central control unit to identify at least one object of interest;
informing a security agency about time and location of said one object of interest, selectively send audio visual recording of said one object of interest, and selectively activating the alarm unit when the central control unit obtains said one object of interest.

18. The method of using a neighborhood watch system according to claim 17, wherein the neighborhood watch system further comprises a communication unit including one of a handheld device comprising a mobile phone and a personal computer operatively connected with the central control unit, wherein said communication unit is operable to configure and modify said base images of the objects stored in the central control unit.

19. The method of using a neighborhood watch system according to claim 18, wherein when the communication unit does not communicate with the central control unit due to a presence of a suspicious jammer, said central control unit automatically triggers an alarm in the communication unit.

20. The method of using a neighborhood watch system according to claim 17, wherein the one object of interest includes at least one of an occurrence of fire, smoke and flood, a fallen tree, a fallen power line, and an accident, a stolen vehicle, a misplaced vehicle, a stolen object, and a lost pet.
